(19) United States
(12) Patent Application Publication
(10) Pub. No.: US 2012/0051836 A1
(43) Pub. Date: Mar. 1, 2012

(54) Flared End Connector Pin Assembly and Associated Ground Engaging Apparatus

(75) Inventor: Scott Jakubisin, Fort Worth, TX (US)

(73) Assignee: HENSLEY INDUSTRIES, INC., Dallas, TX (US)

(21) Appl. No.: 13/154,814

(22) Filed: Jun. 7, 2011

Related U.S. Application Data
(60) Provisional application No. 61/376,839, filed on Aug. 25, 2010.

(51) Int. Cl. F16B 17/00; F16B 1/00

(52) U.S. Cl. 403/376; 403/408.1

(57) ABSTRACT

A connector pin assembly is receivable in aligned openings extending through telescoped ground engaging wear and support members to releasably retain the wear member on the support member. The connector pin assembly has threadingly connected longitudinal portions with flared outer end portions that rampingly drive the wear member rearwardly on the support member, when the longitudinal pin assembly portions are threadingly tightened to one another, to tighten the interfit between the wear and support members. Rotation limiting structures prevent undesired loosening of the threaded interconnection between the longitudinal pin assembly portions.

### CROSS-REFERENCE TO RELATED APPLICATION

This application claims the filing benefit of U.S. Provisional Application Ser. No. 61/376,839 filed on Aug. 25, 2010, such provisional application being incorporated herein by reference in its entirety.

### BACKGROUND OF THE INVENTION

The present invention generally relates to ground engaging apparatus and, in a representatively illustrated embodiment thereof, more particularly relates to a specially designed connector pin assembly operative to releasably connect a ground engaging wear member to a support structure in a telescoped relationship therewith.

In the ground engaging art a need exists for an improved connector pin apparatus useable to releasably couple a replaceable wear member, such as a tooth point or intermediate adapter, to a support structure, such as a base adapter, onto which the wear member is telescoped, with the connector pin apparatus being (1) installable without the need to hammer it into aligned openings in the telescoped support structure and wear member, and (2) being adjustable to provide corresponding operational wear adjustments to the support structure and wear member to periodically “tighten” the wear member onto the support structure as needed. It is to this need that the present invention is primarily directed.

### BRIEF DESCRIPTION OF THE DRAWINGS

FIG. 1 is a partially exploded perspective view of a representative ground engaging support structure, a replaceable ground engaging wear member removably telescoped onto the support structure, and specially designed flared end connector pin apparatus embodying principles of the present invention and utilized to releasably retain the wear member on the support structure and selectively provide operational wear adjustment therebetween;

FIG. 2 is a view similar to that in FIG. 1, but with the wear member removed from the support structure;

FIG. 3 is an enlarged scale side elevational view of the connector pin apparatus by itself in an assembled state;

FIG. 4 is a cross-sectional view through the assembled connector pin apparatus taken generally along line 4-4 of FIG. 3;

FIG. 5A is an enlarged scale cross-sectional view through the telescoped FIG. 1 support structure and wear member, taken generally along line 5-5 of FIG. 1, with the connector pin apparatus operatively installed in the support structure and wear member and the wear member in a newly installed condition;

FIG. 5B is a view similar to that in FIG. 5A, but with the installed connector pin apparatus having been adjusted in a manner compensating for operational wear between the support structure and the wear member in a manner “tightening” the fit of the wear member on the support structure;

FIG. 6 is an enlarged cross-sectional view through the FIG. 1 telescoped support structure and wear member, taken generally along line 6-6 of FIG. 1, with the connector pin apparatus operatively installed in the telescoped support structure and wear member; and

FIG. 7 is an enlarged scale outer end elevational view of a longitudinal portion of the connector pin assembly taken generally along line 7-7 of FIG. 1.

### DETAILED DESCRIPTION

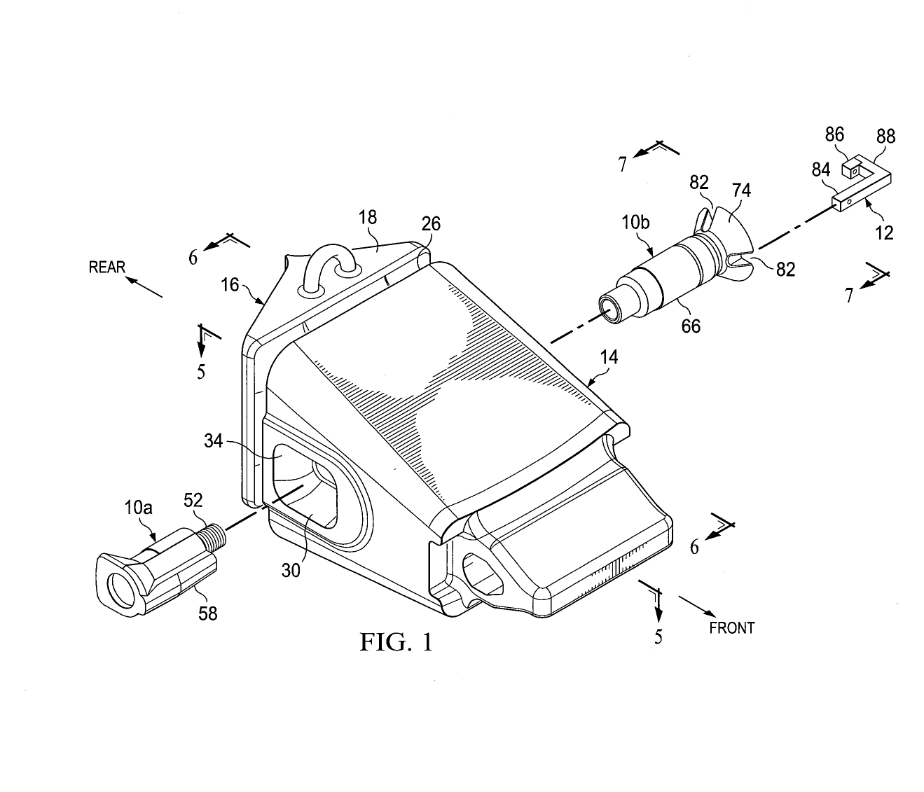

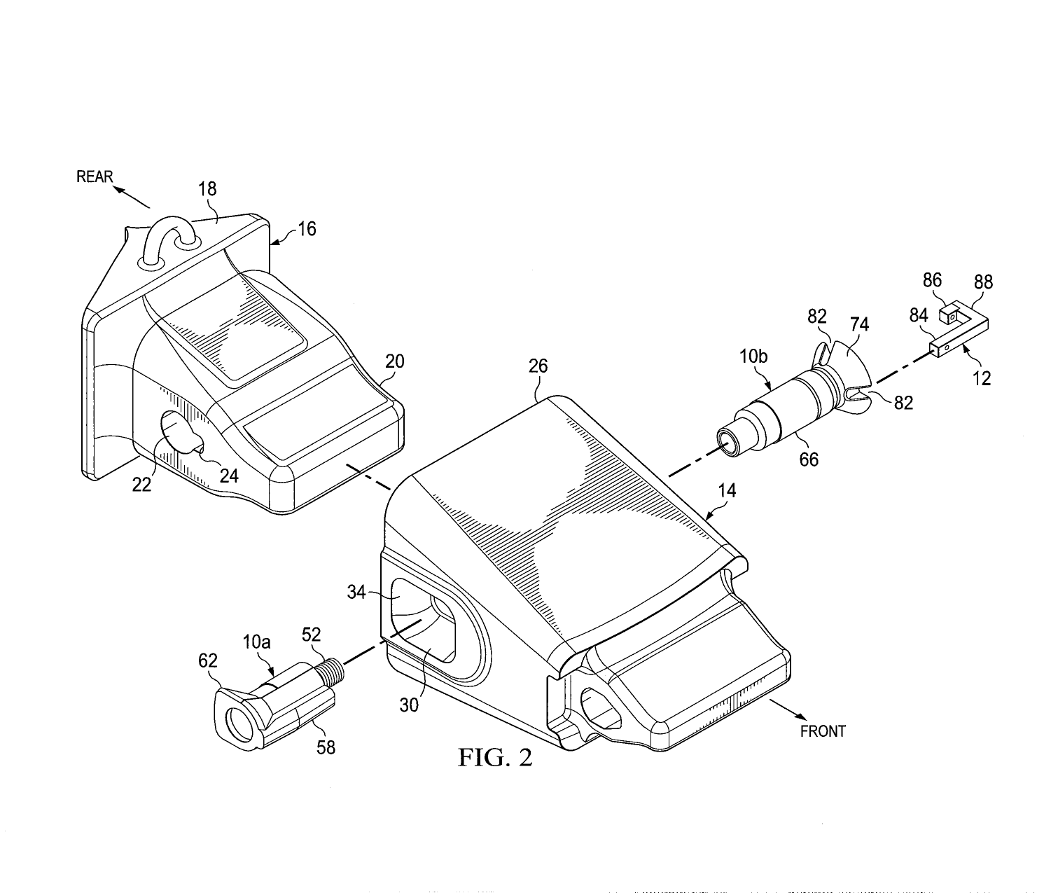

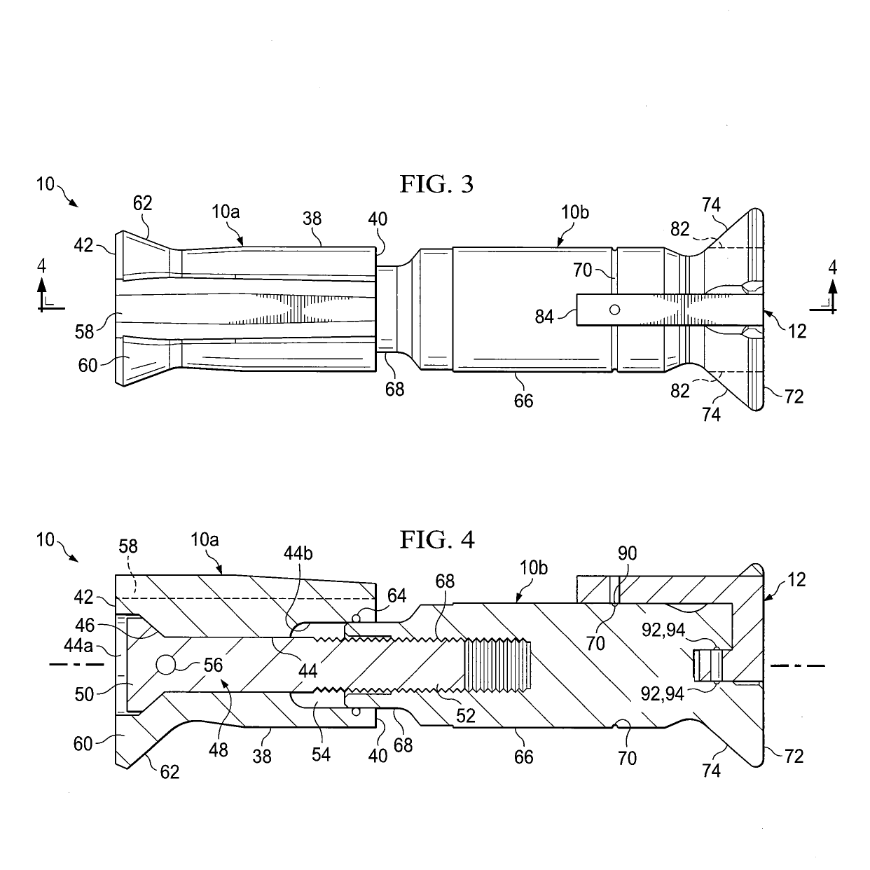

With initial reference to FIGS. 1-4 of the accompanying drawings, the present invention provides a specially designed flared end connector pin assembly 10 (see FIGS. 3 and 4) having threadingly interconnectable longitudinal portions 10a and 10b and an associated locking member 12 associated with portion 10b (see FIGS. 1 and 2). As later described herein, connector pin assembly or apparatus 10 is utilized to captively retain a replaceable ground engaging wear member such as the illustrated intermediate adapter 14 in an outwardly telescoped relationship with a support structure such as the illustrated base adapter 16. Alternatively, if desired, the intermediate adapter 14 could be another type of replaceable ground engaging member such as, for example, a replaceable tooth point.

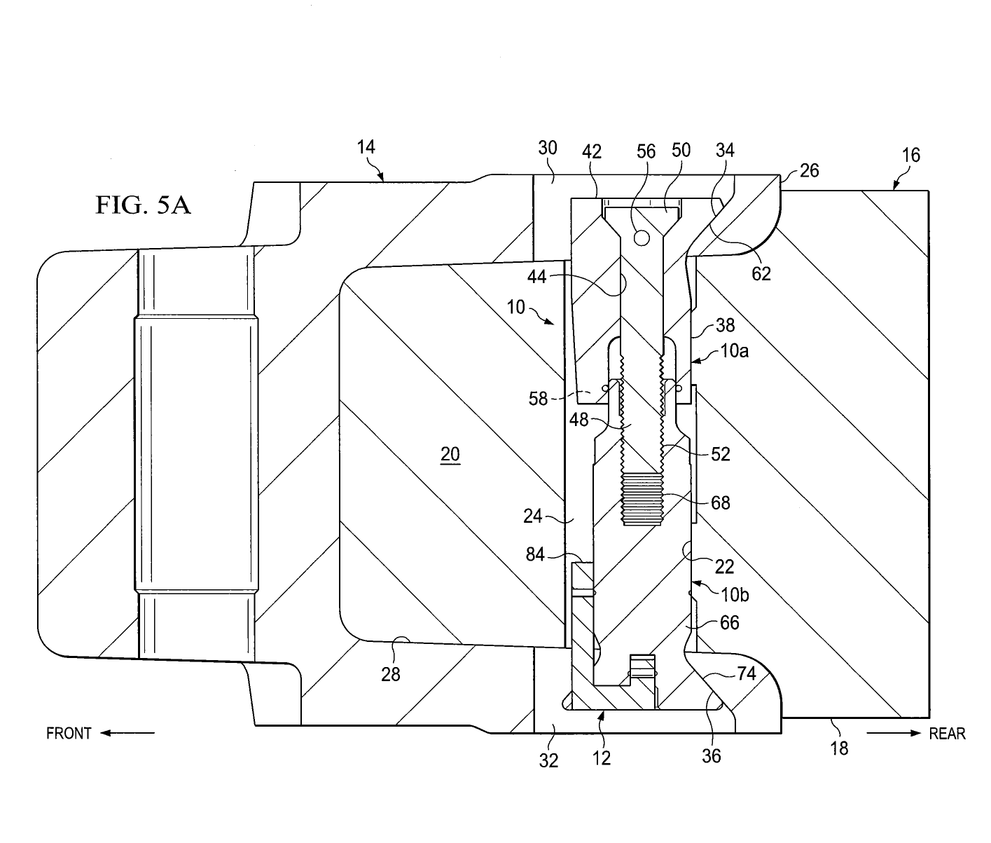

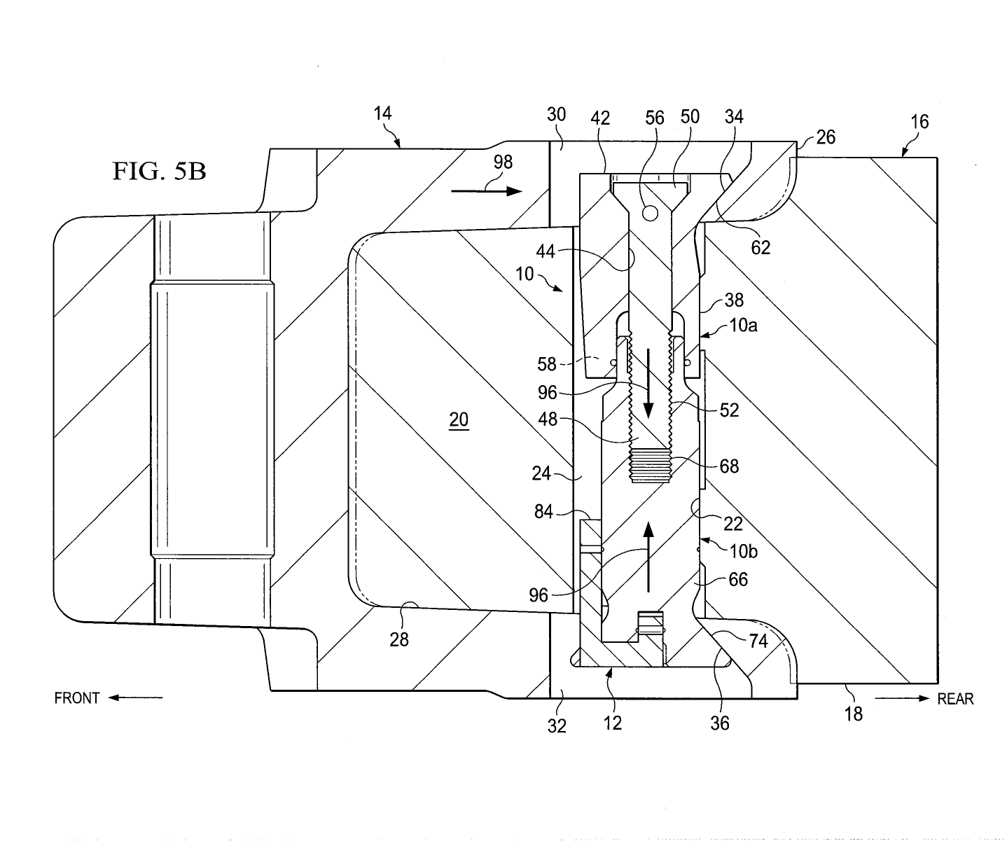

As best illustrated in FIGS. 2, 5A and 6, the base adapter 16 has a rear base portion 18 from which a nose portion 20 forwardly projects. A connector pin opening 22 horizontally extends through the nose portion 20 transverse to its front-to-rear direction. Opening 22 (see FIGS. 2, 5A and 6) has a generally circular cross-section along its length with a lateral enlargement formed on its front side to form a groove 24 within the opening 22. Extending inwardly from the rear end surface 26 of the intermediate adapter 14 (see FIGS. 5A, 5B and 6) is a pocket area 28 that complementarily receives the nose 28 of the base adapter 16. In its opposite vertical side walls the intermediate adapter 16 has connector openings 30, 32 (see FIGS. 5A and 5B) which, with the base adapter nose 20 complementarily received in the intermediate adapter pocket 28, are in alignment with the base adapter nose opening 22. For purposes later described herein, rear portions 34, 36 of the intermediate adapter connector openings 30 and 32 are flared rearwardly and laterally outwardly as may be best seen in FIGS. 5A and 5B.

Turning now to FIGS. 3 and 4, longitudinal portion 10a of the connector pin assembly 10 has a generally tubular outer body 38 with inner and outer ends 40 and 42. A circularly cross-sectioned opening 44 extends axially through the outer body 38 between its ends 40 and 42, with outer and inner end portions 44a, 44b of the opening 44 being radially enlarged as shown in FIG. 4. Opening portion 44a has an annular tapered surface area 46. Longitudinal portion 10a of the connector pin assembly 10 also includes an elongated cylindrical member 48 which is complementarily received within the opening 44.

An enlarged tapered outer head portion 50 of the member 48 is complementarily received in the opening portion 44a, and an externally threaded inner end portion 52 of the member 48 projects outwardly beyond the inner end 40 of the outer body 38. As illustrated, the enlarged body opening portion 44b outwardly circumscribes the threaded end portion 52 and defines therewith an annular pocket 54 within the outer body 38. The tapered head 50 is anchored to the outer body 38 by means of a pin 56 extending transversely through the head 50 and the outer body 38, thereby interconnecting the outer body 38 and the member 48 against both axial and rotational movement relative to one another.

For purposes later described herein, a longitudinally extending, laterally outwardly projecting rib 58 is formed on one side of the outer body 38, a circumferentially extending, radially enlarged area 60, having a flared side surface area 62, is formed on the outer end of the outer body 38 opposite the rib 58, and an O-ring seal 64 is supported in an annular groove (not shown) in the inner surface of the enlarged central opening portion 44b adjacent the inner end 40 of the outer body 38.

Turning now to FIGS. 3, 4 and 7, the longitudinal connector pin assembly portion 10b has an elongated cylindrical body 66 with a reduced diameter inner end portion 68 configured to be complementarily received in the annular pocket area 54 of the longitudinal connector pin assembly portion 10b for sealing engagement with the O-ring seal 64. Extending axially inwardly through the inner end of the body 66 is an internally threaded circularly cross-sectioned opening 68 configured for threaded engagement by the inner end portion 52 of the cylindrical member 48. For purposes later described herein, an annular exterior surface groove 70 is formed on the body 66 between its outer end 72 and the inner termination of the internally threaded opening 68. Additionally, at its outer end the body has an outwardly flared annular outer side surface 74.

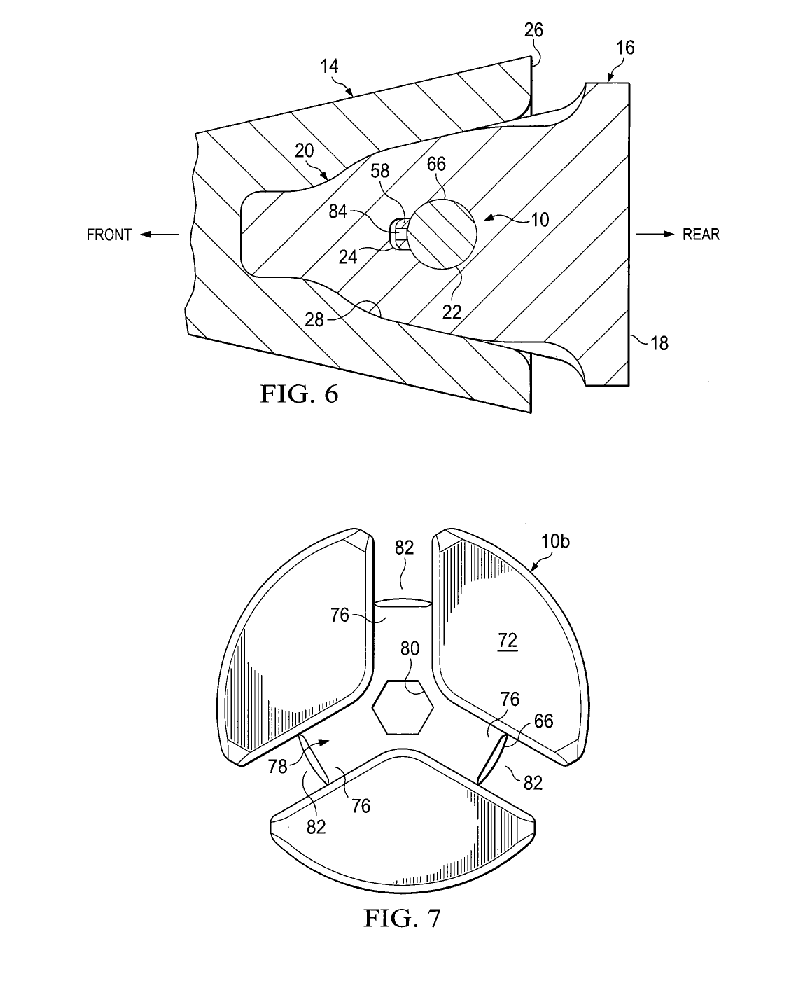

Referring now to FIGS. 3 and 7, formed in the outer end surface 72 of the body 66 of the longitudinal portion 10b of the connector pin assembly 10 are a plurality of circumferentially spaced, radially extending grooves 76 (representatively three in number) that meet in the center of the body 66 (see FIG. 7) and create thereon a recessed end surface area 78. Extending axially inwardly through the surface 78 is a noncircularly cross-sectioned opening 80 (representatively having an hexagonal configuration). At the radially outer ends of the slots 76 axially extending slots 82 (see FIGS. 3 and 7) are additionally cut through the outer end 72 of the body 66.

As illustrated in FIGS. 1 and 4, the locking member portion 12 of the connector pin assembly 10 is generally of a J-shaped configuration, having an elongated leg 84, a shorter parallel leg 86, and a joining leg 88 interconnecting the legs i4 and 86. Legs 84 and 86 representatively have square cross-sections along their lengths, while leg 88 representatively has a hexagonal cross-section adapted to be complementarily received within the hexagonal opening 80. Leg 84 has a spring-loaded detent ball 90 on its inner side, and leg 86 has similar spring-loaded detent balls 92 on side surfaces thereof. Detent ball 90 is adapted for receipt in the body groove 70 (see FIG. 3), and detent balls 92 are adapted for receipt in detent recesses 94 on interior side surface detent recesses 94 within the body opening 80.

To operatively retain the replaceable ground engaging member 14 in its telescoped relationship with the nose portion 20 of the support structure 16 (see FIG. 1), the member 14 (which is illustratively a “new” replaceable ground engaging member) is placed onto the nose 20 in a manner such that the connector openings 30, 32 in the member 14 are aligned with the connector opening 22 in the nose 20. Next, the connector assembly longitudinal portion 10a is inserted into one of the connector openings 30, 32 (representatively into the opening 30 as shown in FIG. 5A) and into the nose opening 22 in a manner such that the rib 58 enters the nose opening groove 24, thereby preventing appreciable rotation between the longitudinal connector pin assembly portion 10a and the nose 20, and the flared side surface portion 62 of the cylindrical member 48 complementarily and slidingly abuts the outwardly flared opening surface 34 of the ground engaging member 14.

Next, the connector assembly longitudinal portion 10b is inserted inwardly through the ground engaging member connector opening 32 into the nose opening 22 and, using a suitable tool (not shown) which mates with the head slots 76 of the body 66, is threaded onto the cylindrical member 48 until the flared end surfaces 62, 74 of the installed connector pin assembly 10 firmly engage the similarly flared surfaces 34, 36 within the ground engaging member connector openings 30, 32 to thereby hold the newly installed ground engaging member 14 in a fully tightened (in an axial direction) position on the support structure nose.

The lock member 12 is then used to prevent the longitudinal connector assembly portion 10b from coming unscrewed from the longitudinal portion 10a. To accomplish this, with one of the head slots 82 (see FIG. 7) aligned with the nose opening groove 24, the free end of the long leg 84 of the lock member 12 is pushed into the groove in a manner causing the short leg 86 of the lock 12 to enter the hex opening 80 (see FIG. 7) and the joining leg 86 of the lock 12 to move into the head slot 76 extending between the long and short legs 84, 86 of the lock 12. The inserted lock 12 is releasably retained in this installed orientation by means of the detent ball 70 (see FIG. 4) snapping into the annular body groove 70 (see FIG. 3), and the detent balls 92 snapping into their associated detent recesses 94 (see FIG. 4) within the hex recess 80 (see FIG. 7). As can best be seen in FIG. 6, the long leg 84 of the installed lock 12 faces opposite sides of the nose opening groove 24 which blocks rotation of the leg 84, and thus the connector body portion 66 to thus prevent the installed connector body portion 66 from being unscrewed from the connector longitudinal portion 10a.

After the interface area between the nose 20 and the ground engaging member 14 becomes worn from ground engaging operations the interfit between these two structures loosens to an extent that the member 14 can undesirably shift forwardly and rearwardly along the nose 20. Using the specially designed flared end connector pin assembly 10 of the present invention the wear member 14 can be rapidly and easily retightened on the support structure 16 by simply removing the lock 12 and further tightening the connector assembly portion 10b onto the portion 10a.

This further tightening of the connector pin assembly portion 10b onto the portion 10 axially draws the flared connector pin surfaces 62 and 74 closer together as indicated by the arrows 96 in FIG. 5B. This, in turn, forcibly moves the replaceable ground engaging wear member 14 in a rearward tightening direction on the nose 20 as indicated by the arrow 98 in FIG. 5B, substantially eliminating the undesirable wear-created “play” between the wear member 14 and the support structure 16. After this simple retightening procedure the removed lock 12 is replaced on the body 66 as previously described.

When the worn ground engaging member 14 needs to be replaced, all that is necessary is to remove the lock 12 from the body 66, unscrew the connector pin assembly longitudinal portions 10a, 10b from one another and remove them from the telescoped wear member 14 and support structure 16, and then remove the worn wear member 14 from the support structure 16. A new wear member 14 is then placed on the support structure 16 and the connector pin assembly re-installed in the manner previously described herein.

A variety of modifications may be made to the representatively illustrated and described connector pin assembly 10 without departing from principles of the present invention. For example, if desired, the assembly portions 10a, 10b could be modified in a manner such that the portion 10b could be screwed into the portion 10a. Further, the cylindrical member 48 of the assembly portion 10a could be supported in a manner such that could have a limited degree of lateral movement relative to the body 38 (see FIG. 5A) to facilitate threaded interconnection between the assembly longitudinal portions 10a and 10b. Additionally, the lock 12 could have a variety of alternative configurations, and the head portion of the body 66 could have a greater or lesser number of slots formed therein.

As can be readily seen from the foregoing, the present invention provides a simple connector pin assembly which can be installed in telescoped wear member/support structure apparatus without the need to pound the connector pin assembly into place, with the installed connector pin assembly being useable to maintain a desirably tight fit between the wear member and support structure despite operational loosening between such elements.

The foregoing detailed description is to be clearly understood as being given by way of illustration and example only, the spirit and scope of the present invention being limited solely by the appended claims.

What is claimed is:

1. A connector pin assembly for use in captively retaining on a nose portion of a support structure a ground engaging wear member rearwardly telescoped onto the nose portion and having an opposing pair of walls respectively having first and second connector openings extending therethrough in general alignment with a connector opening extending through the nose portion, the wear member, in response to internal surface wear thereon, being rearwardly shiftable from an initially tightened position on the support structure, said connector pin assembly comprising:
a connector pin structure having first and second longitudinal portions being configured to be inserted in opposite directions through the wear member connector openings into the nose portion connector opening, said first and second longitudinal portions having outer end portions with axially and radially outwardly flared circumferential side surface portions configured to rampingly engage facing interior side surface portions of the first and second connector openings, the inserted first and second longitudinal portions being threadingly connectable to one another and tightenable to one another in a manner drawing said flared circumferential side surface portions toward one another and thereby forcibly move the wear member rearwardly along the nose portion to tighten the fit of the wear member on the support structure;
a first rotation limiting structure carried by said first longitudinal portion and configured to engage the nose portion in a manner substantially preventing rotation of said first longitudinal portion within the nose portion opening; and
a second rotation limiting structure operative to selectively limit rotation of said second longitudinal portion within the nose portion in a manner loosening the threaded interconnection between said first and second longitudinal portions.

2. The connector pin assembly of claim 1 wherein:
said first and second connector pin structure longitudinal portions are telescopable with one another.

3. The connector pin assembly of claim 1 wherein:
said first rotation limiting structure comprises an axially extending, laterally outwardly projecting rib disposed on an outer side surface portion of said first longitudinal portion of said connector pin structure.

4. The connector pin assembly of claim 1 wherein:
said second rotation limiting structure is removably connectable to said second longitudinal portion of said connector pin structure.

5. The connector pin assembly of claim 4 wherein:
said second longitudinal portion of said connector pin structure has an axially outwardly facing outer end surface with a first slot formed therein, a noncircularly cross-sectioned recess axially extending into said second longitudinal portion within said first slot, and a second slot extending axially through a peripheral portion of the outer end of said second longitudinal portion from an outer end of said first slot; and
said second rotation limiting structure is a generally J-shaped lock member having a first leg nonrotatably and removably receivable in said recess, a second leg spaced from and parallel to said first leg and extendable through said second slot, and a joining leg interconnecting said first and second legs and being receivable in said first slot.

6. The connector pin assembly of claim 1 wherein:
said first longitudinal portion of said connector pin structure comprises a hollow cylindrical body with a passage extending therethrough between inner and outer ends thereof, and a cylindrical member having an outer longitudinal portion received and anchored within said passage, and an outer externally threaded longitudinal portion projecting outwardly from said passage, and
said second longitudinal portion of said connector pin structure comprises a cylindrical body with an internally threaded axial passage into which said outer externally threaded longitudinal portion of said first longitudinal portion may be threaded.

7. Ground engaging apparatus comprising:
a support structure having a forwardly projecting nose portion with a connector opening extending therethrough;
a hollow replaceable wear member rearwardly telescoped onto said nose portion and having opposite exterior side walls with first and second connector openings extending therethrough in general alignment with said connector opening of said nose portion, said wear member, in response to interior surface wear therein, being rearwardly shiftable on said nose portion from an initial tightened position thereon to a rearwardly shifted tightened position thereon, each of said first and second wear member connector openings having a rear interior surface portion which is generally planar and rearwardly tilted; and
a connector pin assembly captively and releasably retaining said wear member on said nose portion of said support structure, said connector pin assembly comprising:
threadingly interconnected first and second longitudinal connector pin portions with axially and radially outwardly flared side surface portions on outer ends thereof disposed within first and second wear member connector openings with said flared outer end side surface portions complementarily and slidably engaging said rear interior surface portions of said first and second wear member connector openings in a manner such that rotational tightening of said first and second longitudinal portions forcibly draws said outwardly flared outer end side surface portions thereof toward one another to thereby cause them to slide along said tilted first and second wear member connector opening surface portions and rearwardly drive said wear member along said nose portion from a loosened position thereon to a re-tightened position thereon,
a first rotation limiting structure carried by said first longitudinal portion and engaging an interior surface area of said nose portion connector opening in a manner preventing appreciable rotation of said first longitudinal portion relative to said nose portion; and
a second rotation limiting structure limiting rotation of said second longitudinal portion within said nose portion in a manner loosening the threaded interconnection between said first and second longitudinal portions.

8. The ground engaging apparatus of claim 7 wherein:
said first and second connector pin longitudinal portions are telescoped with one another.

9. The ground engaging apparatus of claim 7 wherein:
said first rotation limiting structure comprises an axially extending, laterally outwardly projecting rib disposed on an outer side surface portion of said first longitudinal portion of said connector pin structure.

10. The ground engaging apparatus of claim 7 wherein:
said second rotation limiting structure is removably connected to said second longitudinal portion of said connector pin structure.

11. The ground engaging apparatus of claim 10 wherein:
said second longitudinal portion of said connector pin structure has an axially outwardly facing outer end surface with a first slot formed therein, a noncircularly cross-sectioned recess axially extending into said second longitudinal portion within said first slot, and a second slot extending axially through a peripheral portion of the outer end of said second longitudinal portion from an outer end of said first slot; and
said second rotation limiting structure is a generally J-shaped lock member having a first leg nonrotatably and removably received in said recess, a second leg spaced from and parallel to said first leg and extending through said second slot, and a joining leg interconnecting said first and second legs and being received in said first slot.

12. The ground engaging apparatus of claim 7 wherein:
said first longitudinal portion of said connector pin structure comprises a hollow cylindrical body with a passage extending therethrough between inner and outer ends thereof, and a cylindrical member having an outer longitudinal portion received and anchored within said passage, and an outer externally threaded longitudinal portion projecting outwardly from said passage, and
said second longitudinal portion of said connector pin structure comprises a cylindrical body with an internally threaded axial passage into which said outer externally threaded longitudinal portion of said first longitudinal portion is threaded.

13. The ground engaging apparatus of claim 7 wherein:
said support structure is an adapter.

14. The ground engaging apparatus of claim 13 wherein:
said wear member is a replaceable tooth point.

15. The ground engaging apparatus of claim 13 wherein:
said support structure is a base adapter, and
said wear member is an intermediate adapter.

16. A replaceable ground engaging wear member comprising:
a front end;
a rear end through which a pocket area inwardly extends, said pocket area being configured to complementarily receive a nose portion of a support structure; and
first and second opposite side walls with aligned connector pin openings extending inwardly therethrough into said pocket area, each of said connector pin openings having a rearwardly and outwardly tilted, substantially planar rear interior surface area.

17. The replaceable ground engaging wear member of claim 16 wherein:
said ground engaging wear member is a replaceable tooth point.

18. The replaceable ground engaging wear member of claim 16 wherein:
said ground engaging wear member is an adapter.
